(19) United States
(12) Patent Application Publication
(10) Pub. No.: US 2005/0090627 A1
(43) Pub. Date: Apr. 28, 2005

(54) Low-temperature-curing epoxy-functional powder coating compositions

(75) Inventors: Andreas Wenning, Nottuln (DE); Emmanouil Sprou, Dorsten (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/959,628

(22) Filed: Oct. 7, 2004

(30) Foreign Application Priority Data
Oct. 22, 2003 (DE) 103 48 965.7

(51) Int. Cl. C08L 63/00

(52) U.S. Cl. 525/533

(57) ABSTRACT

Epoxy-functional powder coating compositions which cure at low baking temperatures, a process for preparing such compositions, and their use for producing plastics, especially powder coatings, which crosslink at low baking temperatures to give high-gloss or matt, light-stable and weather-stable coating films.

### BACKGROUND OF THE INVENTION

1. Field of the Invention

The invention relates to powder coating compositions which are epoxy-functional (i.e., contain epoxide groups) and cure at low baking temperatures, to a process for preparing powder coating compositions, and to their use for producing plastics, especially polyester powder coatings, which crosslink at low baking temperatures to give high-gloss or matt, light-stable and weather-stable coating films.

2. Description of the Related Art

Powder coating materials based on epoxy-functional compounds and acid-functional polyesters may be used to produce corrosion-resistant and weather-stable powder coatings. These epoxy-functional compounds act as curing agents. By way of example U.S. Pat. No. 3,547,918 and JP 50 160 287 describe triglycidyl isocyanurate (TGIC), and U.S. Pat. No. 5,294,683 describes mixtures of a solid polyglycidyl compound, diglycidyl terephthalate for example, with a further polyglycidyl compound normally in liquid form, triglycidyl trimellitate, for example, as crosslinkers for powder coating materials based on carboxyl-terminated polyesters.

A feature common to the powder coating compositions based on the abovementioned epoxy-functional compounds is the absence of any emission of volatile compounds during the curing reaction. Moreover, the baking and curing temperatures of not less than 180° C. high.

### SUMMARY OF THE INVENTION

Accordingly, it is one object of the present invention, therefore, to prepare highly reactive, epoxy-functional powder coating compositions which can be cured at very low temperatures and are suitable in particular for producing plastics and high-gloss or matt, light-stable and weather-stable powder coatings.

Surprisingly it has been found that certain catalysts may accelerate the reaction of the epoxide groups with the acid groups that, the cure temperature of powder coating compositions can be lowered considerably using known polyglycidyl compounds as powder coating curing agents.

### DETAILED DESCRIPTION OF THE DRAWINGS

In one aspect of the invention powder coating compositions are described which comprise

A) at least one compound containing on average at least two epoxide groups and having a melting point of from 40 to 130° C. and a number-average molar mass of less than 5,000 g/mol,

B) at least one carboxyl-containing polymer having a melting point of from 40 to 130° C., an acid number of from 10 to 200 mg KOH/g, and a hydroxyl number of from 0 to 30 mg KOH/g,

C) at least one catalyst selected from the group consisting of a quaternary ammonium hydroxide, a quaternary ammonium fluoride, and a quaternary ammonium carboxylate,

D) if desired, auxiliaries and additives,

where the two components A) and B) are present in a ratio such that for each carboxyl group of component B) there are from 0.5 to 1.3 epoxide groups of component A) and the catalyst C) present in amount of from 0.001 to 3% by weight of the total amount of components A) and B).

The invention further provides a process for preparing the powder coating compositions.

The invention also provides a method for the use of the powder coating compositions of the invention of produce powder coatings on metal, plastic, glass, wood or leather substrates or other heat-resistant substrates.

Likewise provided by the present invention are metal-coating compositions, especially for automobile bodies, cycles and motorcycles, architectural components, and household appliances, wood-coating compositions, glass-coating compositions, leather-coating compositions, and plastics-coating compositions, all containing a powder coating composition comprising

A) at least one compound containing on average at least two epoxide groups and having a melting point of from 40 to 130° C. and a number-average molar mass of less than 5,000 g/mol,

B) at least one carboxyl-containing polymer having a melting point of from 40 to 130° C., an acid number of from 10 to 200 mg KOH/g, and a hydroxyl number of from 0 to 50 mg KOH/g,

C) at least one catalyst selected from the group consisting of a quaternary ammonium hydroxide, a quaternary ammonium fluoride, and a quaternary ammonium carboxylate,

D) if desired, auxiliaries and additives,

where the two components A) and B) are present in a ratio such that for each carboxyl group of component B) there are from 0.5 to 1.3 epoxide groups of component A) and the catalyst C) is present in an amount of from 0.001 to 3% by weight of the total amount of components A) and B).

The epoxy-functional compounds A) may preferably be in solid form below 40° C. and in liquid form above 130° C. and preferably have number-average molar masses of less than 5,000. Examples of A) include polyglycidyl compounds having at least two epoxide groups. Specific examples include solid diglycidyl compounds, such as diglycidyl terephthalate, or solid triglycidyl compounds, such as triglycidyl trimesate or triglycidyl isocyanurate (TGIC). TGIC is in particular suitable for powder coatings which are resistant to outdoor conditions. The preparation of TGIC is described in, for example, U.S. Pat. No. 3,547,918 and JP 50 160 287.

The epoxy-functional compounds A) may further include solid compositions comprising one or more solid diglycidyl or polyglycidyl compounds and a diglycidyl or polyglycidyl compound which is normally present in liquid form at temperatures below 40° C., preferably 30° C., or a mixture of diglycidyl or polyglycidyl compounds normally present in liquid form. These compositions are preferably solid and nontacky, since the low molecular mass, solid diglycidyl or polyglycidyl compounds are able to absorb or act as solvents for large amounts of other, liquid diglycidyl or polyglycidyl compounds of similar molecular weight. Solid compositions of this kind are described in, for example, U.S. Pat. No. 5,457,168.

For the carboxyl-containing polymers B) it is preferred to use polyesters, polyethers, polyacrylates, polyurethanes and/or polycarbonates having an acid number of from 10 to 200 mg KOH/g and a melting point of from 40 to 130° C.

Particular preference is given to using amorphous polyesters having an acid number of from 10 to 200 mg KOH/g, a glass transition temperature of from 30 to 90° C. and a melting point of between 40 and 130° C.

The acidic, amorphous polyesters may be obtained conventionally by condensation in an inert gas atmosphere at temperatures from 100 to 260° C., preferably from 130 to 220° C., in the melt or in an azeotropic regime, as described in, for example, Methoden der Organischen Chemie (Houben-Weyl), vol. 14/2, 1-29, 40-47, Georg Thieme Verlag, Stuttgart, 1963 or C. R. Martens, Alkyd Resins, 51-59, Reinhold Plastics Appl. Series, Reinhold Publishing Comp., New York, 1961 (incorporated herein by reference).

Examples of carboxylic acids that may be used for preparing the polyesters include: succinic, adipic, suberic, azelaic, sebacic, phthalic, terephthalic, isophthalic, trimellitic, pyromellitic, tetrahydrophthalic, hexahydrophthalic, hexahydroterephthalic, dichlorophthalic, tetrachlorophthalic, endomethylenetetrahydrophthalic, glutaric, and 1,4-cyclohexanedicarboxylic acid and esters thereof. Particularly preferred are isophthalic acid, terephthalic acid, hexahydroterephthalic acid, hexahydrophthalic acid, adipic acid, and succinic acid and esters thereof.

Examples of suitable polyols for preparing the polyesters include monoethylene glycol, 1,2- and 1,3-propylene glycol, 1,4- and 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)-tricyclo[5.2.1.02,6]decane (Dicidol), 1,4-bis(hydroxymethyl)cyclohexane, 2,2-bis(4-hydroxycyclohexyl)propane, 2,2-bis[4-(β-hydroxyethoxy)phenyl]propane, 2-methyl-propane-1,3-diol, 2-methylpentane-1,5-diol, 2,2,4(2,4,4)-trimethylhexane-1,6-diol, glycerol, trimethylolpropane, trimethylolethane, hexane-1,2,6-triol, butane-1,2,4-triol, tris(β-hydroxyethyl)isocyanurate, pentaerythritol, mannitol and sorbitol, and also diethylene glycol, triethylene glycol, tetraethylene glycol, dipropylene glycol, polypropylene glycols, polybutylene glycols, xylylene glycol, and neopentyl glycol hydroxypivalate.

Preferred alcohols are monoethylene glycol, butane-1,4-diol, pentane-1,5-diol, hexane-1,6-diol, neopentyl glycol, 1,4-bis(hydroxymethyl)cyclohexane, 2,2,4(2,4,4)-trimethylhexane-1,6-diol, neopentyl glycol hydroxypivalate, trimethylolpropane, and glycerol.

The amorphous polyesters thus prepared may preferably have a glass transition temperature of from 30 to 90° C. and an acid number of from 10 to 200 mg KOH/g.

Mixtures of such polymers can also be used. The amount of the carboxyl-containing polymers is preferred to be powder for each carboxyl group of the polymer, from 0.5 to 1.3, preferably from 0.8 to 1.2, epoxide groups of the crosslinker.

Optionally the polymers may further contain hydroxyl groups as well as the carboxyl groups. The OH number may be in the range from 0 to 50 mg KOH/g. To crosslink the hydroxyl groups it is possible if necessary to use a further crosslinker such as, for example, a polyisocyanate compound with or without uretdione groups. Polyisocyanate curing agents of this kind are known and are described in, for example, DE-A 27 12 931, DE-A 30 30 539, DE-A 30 30 572, and U.S. Pat. No. 6,613,861 (each of which is incorporated herein by reference).

Catalysts C) which may be used to accelerate the crosslinking reaction of the epoxy-functional compound A) with the carboxyl-containing polymer B) include quaternary ammonium salts with hydroxides, fluorides or carboxylates. They are described in, for example, WO 00/34355, U.S. 2003/0153713, DE 102 05 608, and DE 103 20 266 (each of which is incorporated herein by reference). Examples include tetraalkylammonium hydroxides such as tetrabutylammonium hydroxide, tetraalkylammonium fluorides such as tetrabutylammonium fluoride or tetraalkylammonium benzoates such as tetrabutylammonium benzoate, for example. They may be used alone or in mixtures.

The fraction of the catalyst may be from 0.001 to 3% by weight of the total amount of the powder coating compositions of the invention.

For preparing the powder coating materials it is possible to add auxiliaries and additives D) which are customary in powder coating technology, such as leveling agents, e.g., polysilicones or acrylates, light stabilizers, e.g., sterically hindered amines, or other auxiliaries, as described in U.S. Pat. No. 6,613,861 (each of which is incorporated herein by reference) for example, in a total amount of from 0.05 to 5% by weight. Fillers and pigments, such as titanium dioxide, may be added in an amount up to 50% by weight of the total composition.

Optionally it is possible for additional catalysts such as are already known in epoxy chemistry to be present. These include, for example, tertiary amines, such as 1,4 diazabicyclo[2.2.2]octane, for example, in amounts of from 0.001 to 1% by weight.

All of the constituents for preparing a powder coating composition may be homogenized in suitable apparatus together, or as mixtures alone, such as heatable kneading apparatus, for example, but preferably by extrusion, in which case upper temperature limits of 120 to 130° C. are preferably not exceeded. After cooling to room temperature and appropriate comminution, the extruded mass may be ground to give a ready-to-spray powder. This powder may be applied to appropriate substrates in accordance with the known techniques, including electrostatic powder spraying and fluid-bed sintering with or without electrostatic assistance, for example. Following powder application, the coated workpieces are cured by heating at a temperature from 120 to 220° C. for from 4 to 60 minutes, preferably at 120 to 180° C. for from 6 to 30 minutes.

The low-temperature-curing powder coating compositions of the invention are cured with particular preference at temperatures of from 120 to 160° C. Their use allows not only the saving of energy and (cure) time but also coating of temperature-sensitive substrates which at temperatures of 180° C. or more may exhibit unwanted yellowing, decomposition and/or embrittlement. Besides metal, glass, wood, leather, plastics, and MDF board, certain aluminum substrates as well are suitable for this application. In the case of the latter substrates, too high a temperature load may occasionally leads to an unwanted change in the crystal structure.

The powder coatings produced from the powder coating compositions may be high-gloss or matt, are light-stable and weather-stable, and exhibit effective leveling.

The subject matter of the invention is illustrated below with reference to examples which are not intended to further limit the invention.

### EXAMPLES

### Powder Coating Materials

General Preparation Procedure

The ground products—epoxy-functional compound, polyester, catalyst, leveling agent, and white pigment—are intimately mixed in an edge runner mill and then homogenized in an extruder at from 80 to 140° C. After cooling, the extrudate is fractionated and ground with a pinned disk mill to a particle size <100 μm. The powder thus produced is applied to degreased, optionally pretreated iron panels using an electrostatic powder spraying unit at 60 kV.

| Ingredients | Product description, manufacturer |
|---|---|
| ARALDIT PT 810 | triglycidyl isocyanurate (TGIC), epoxy equivalent |
| | 100-108 g/eq, Vantico AG |
| ARALDIT PT 910 | polyfunctional glycidyl ester, epoxy equivalent |
| | 141-154 g/eq, Vantico AG |
| URALAC P 5000 | COOH polyester, AN: 32-38; Tg 58° C.; UCB |
| KRONOS 2160 | titanium dioxide, Kronos |
| RESIFLOW PV 88 | leveling agent, Worlee-Chemie |
| BENZOIN | devolatilizer, Merck-Schuchardt |
| TBAH | tetrabutylammonium hydroxide, Aldrich |

AN: acid number, consumption in mg KOH/g polymer,
Tg: glass transition temperature

Powder coating compositions (amounts in % by weight):

| | | | | Gel time (s) at |
|---|---|---|---|---|
| Examples | Crosslinker | URALAC P 5000 | TBAH | 160° C.* |
| 1 | 3.61 PT 810 | 61.97 | 2.91 | 35 |
| C 1 | 3.77 PT 810 | 64.73 | — | >600 |
| 2 | 5.26 PT 910 | 60.40 | 2.84 | 50 |
| C 2 | 5.49 PT 910 | 63.01 | — | >600 |

*to DIN 55990, Part 8

Additionally in each of the formulations 30.0% by weight of KRONOS 2160, 1.0% by weight of RESIFLOW PV 88, and 0.5% by weight of benzoin were used.

The inventive examples 1 and 2 exhibit a much shorter gel time and hence more rapid crosslinking than the noninventive, comparative examples C1 and C2.

German application 10348965.7 filed on Oct. 22, 2003 is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

1. A powder coating composition comprising
A) at least one compound containing on average at least two epoxide groups and having a melting point of from 40 to 1 30° C. and a number-average molar mass of less than 5,000 g/mol,
B) at least one carboxyl-containing polymer having a melting point of from 40 to 130° C., an acid number of from 10 to 200 mg KOH/g, and a hydroxyl number of from 0 to 50 mg KOH/g, and
C) at least one catalyst selected from the group consisting of a quaternary ammonium hydroxide, a quaternary ammonium fluoride, and a quaternary ammonium carboxylate,
wherein from 0.5 to 1.3 epoxide groups of A) are present for each carboxyl group of B), and the catalyst C) is present in an amount of from 0.001 to 3% by weight based on the total amount of components A) and B).

2. The powder coating composition as claimed in claim 1, wherein A) comprises at least one of a solid diglycidyl compound or a solid triglycidyl compound.

3. The powder coating composition as claimed in claim 1, wherein A) comprises at least one solid composition comprising one or more of a solid diglycidyl or a solid polyglycidyl compound, and at least one diglycidyl or a polyglycidyl compound which is in liquid form at temperatures below 40° C.

4. The powder coating composition as claimed in claim 1, wherein A) comprises at least one of a diglycidyl terephthalate or a triglycidyl isocyanurate.

5. The powder coating composition as claimed in claim 1, wherein A) comprises a mixture of diglycidyl terephthalate and triglycidyl trimesate.

6. The powder coating composition as claimed in claim 1, wherein B) comprises at least one of at least one polyester, polyether, polyacrylate, polyurethane or polycarbonate having an acid number of from 10 to 200 mg KOH/g and a melting point of from 40 to 130° C.

7. The powder coating composition as claimed in claim 1, wherein B) comprises at least one amorphous polyester having an acid number of from 10 to 200 mg KOH/g, a hydroxyl number of from 0 to 50 mg KOH/g, a glass transition temperature of from 30 to 90° C., and a melting point of between 40 and 130° C.

8. The powder coating composition as claimed in claim 1, wherein from 0.8 to 1.2 epoxide groups of the compound A) are present for each carboxyl group of the polymer B).

9. The powder coating composition as claimed in claim 1, comprising at least one polyisocyanate compound.

10. The powder coating composition as claimed in claim 1, wherein the C) comprises at least one of a tetraalkylammonium hydroxide, a tetraalkylammonium fluoride or a tetraalkylammonium benzoate.

11. The powder coating composition as claimed in claim 1, wherein the C) comprises at least one of a tetrabutylammonium hydroxide, a tetrabutylammonium fluoride or a tetrabutylammonium benzoate.

12. The powder coating composition as claimed in claim 1, further comprising at least one additive or auxiliary D) selected from the group consisting of a leveling agent, a light stabilizer, a filler, an additional catalyst and a pigment.

13. A process for preparing a powder coating composition comprising mixing at least A), B), and C) in a heatable apparatus at a temperature of not greater than 130° C.,
A) at least one compound containing on average at least two epoxide groups and having a melting point of from 40 to 130° C. and a number-average molar mass of less than 5,000 g/mol,
B) at least one carboxyl-containing polymer having a melting point of from 40 to 130° C., an acid number of from 10 to 200 mg KOH/g, and a hydroxyl number of from 0 to 50 mg KOH/g, and
C) at least one catalyst selected from the group consisting of a quaternary ammonium hydroxide, quaternary ammonium fluoride, and a quaternary ammonium carboxylate,
wherein from 0.5 to 1.3 epoxide groups of A) are present for each carboxyl group of B), and the catalyst C) is present in an amount of from 0.001 to 3% by weight of the total amount of components A) and B).

14. A method comprising
applying a powder coating composition on a substrate and then curing the powder coating composition present on the substrate;
wherein the powder coating composition comprises
A) at least one compound containing on average at least two epoxide groups and having a melting point of from 40 to 130° C. and a number-average molar mass of less than 5,000 g/mol,
B) at least one carboxyl-containing polymer having a melting point of from 40 to 130° C., an acid number of from 10 to 200 mg KOH/g, and a hydroxyl number of from 0 to 50 mg KOH/g, and
C) at least one catalyst selected from the group consisting of a quaternary ammonium hydroxide, a quaternary ammonium fluoride, and a quaternary ammonium carboxylate,
wherein from 0.5 to 1.3 epoxide groups of A) are present for each carboxyl group of B), and the catalyst C) is present in an amount of from 0.001 to 3% by weight based on the total amount of components A) and B).

15. The powder coating composition of claim 3 wherein the at least one diglycidyl or polyglycidyl compound is in liquid form at a temperature below 30° C.

16. The method as claimed in claim 14, wherein the substrate is metal, plastic, wood, glass or leather.

17. The power coating composition of claim 1, consisting essentially of A), B), and C).

18. The powder coating composition as claimed in claim 9, wherein the polyisocyanate compound has one or more uretdione groups.

19. The powder coating composition as claimed in claim 9, wherein the polyisocyanate compound has no uretdione groups.

20. The process as claimed in claim 13, wherein the mixing is carried out at a temperature of not greater than 120° C.

21. A coating comprising the powder coating composition of claim 1 on a substrate, wherein the powder coating composition is cured.

22. A metal-coating composition comprising the composition as claimed in claim 1.

23. A wood-coating composition comprising the composition as claimed in claim 1.

24. A leather-coating composition comprising the compositions claimed in claim 1.

25. A plastic-coating composition comprising the composition as claimed in claim 1.

26. A glass-coating composition comprising the composition as claimed in claim 1.

27. The method of claim 14, wherein the curing is carried out at a temperature of from 120° C. to 160° C.
